(19) United States
(12) Patent Application Publication
(10) Pub. No.: US 2005/0236888 A1
(43) Pub. Date: Oct. 27, 2005

(54) Hydraulic brake coupling for use with a trailer

(76) Inventor: J. Alan Corbin, Greenwood, IN (US)

Correspondence Address: INDIANO VAUGHAN & ROBERTS P.A., ONE N. PENNSYLVANIA STREET, SUITE 850, INDIANAPOLIS, IN, 46204, US

(21) Appl. No.: 10/831,414

(22) Filed: Apr. 23, 2004

(51) Int. Cl. B60T 13/00

(52) U.S. Cl. 303/7

(57) ABSTRACT

A hydraulic brake coupling that connects a vehicle hydraulic brake system of a vehicle to a trailer hydraulic brake system of a trailer. The hydraulic brake coupling includes a vehicle coupler that is fluidly connected to the vehicle hydraulic brake system, and a trailer coupler that is fluidly connected to the trailer brake system. The vehicle coupler and the trailer coupler are designed to make a fluid tight connection. When the vehicle coupler is coupled to the trailer coupler, activating the vehicle hydraulic brake system causes fluid pressure to pass from the vehicle brake system, through the vehicle coupler and the trailer coupler to the trailer brake system.

### I. TECHNICAL FIELD OF THE INVENTION

The present invention relates to brake systems used in vehicles, and in particular, to a brake system that is especially useful for connecting hydraulic brakes of a towing vehicle to a hydraulic brake system of a towed vehicle, such as a trailer.

### II. BACKGROUND OF THE INVENTION

Currently there are three types of braking systems that are used on trailers: pneumatic braking systems, surge braking systems and electric braking systems In fact, many small trailers have no brakes at all but depend on the towing vehicle to provide braking.

Pneumatic brake sytems are used primarily on large commercial trailers, such as 18-wheel trailers. The pneumatic brakes are powered by an air compressor in the truck. There are coupling ports on the back of the truck that hook up to hoses that are coupled to the trailer. The way a pneumatic brake works is that the brakes are biased into the on or gripping position. The air compressor generates air when the truck is turned on. The air pressure that is generated within the truck flows through the air compressor system into lines that connect to the coupling. The coupling is connected to the hoses that transmit the air to the trailer and into the trailer's pneumatic or air braking system. The air pressure then actuates the brake to release from the drum, thereby allowing the truck trailer to move. Pneumatic brakes work very well, but they do require an air compressor. Light duty vehicles, such as cars and pick-up trucks, generally do not have an air compressor that can power a pneumatic braking system. Trailers with air brakes are not generally used with light duty trucks, boat trailers, U-Haul trailers and the like.

Surge brakes work on a hydraulic system that is contained wholly within the trailer. The tongue on the trailer can pivot along a horizontal axis so that the trailer hitch ball holder can swing like a pendulum between a point where it is swinging up toward the truck to a point where it is swinging back toward the trailer. When the brakes are applied on the towing vehicle, the trailer ball holder will pivot backward which forces a piston into the hydraulic line that pushes the hydraulic fluid back into the brakes of the trailer that then applies the trailer brakes. When the towing vehicle pulls away from the trailer, the trailer ball holder will pivots forward which releases the piston in the hydraulic line and releases the trailer brakes. Surge brakes work reasonably well, and are typically used on boat trailers, U-Haul trailers and the like.

Electric brakes on a trailer are basically actuated by the brake lights of the towing vehicle, because a trailer typically will have a connection to the brake lights of the towing vehicle. When the driver of the towing vehicle applies the brakes, the brake lights are activated which in turn actuates the electric brakes on the trailer to grab the wheel. Electric brakes have some issues in reliability and they also do not work well with boat trailers because the water, especially salt water, will damage the electrical system. Since a boat trailer is, by definition, backed into a lake or other water body in order to off load the boat, the introduction of the water to the electric brakes causes them to stop working. For that reason, surge brakes are the type that are typically used on boat trailers that do have brakes.

The brake systems of light duty vehicles, such as cars and pick-up trucks, typically are hydraulic brakes. They have a brake pump and brake lines that go to the wheels and are filled with fluid. When the driver applies the brakes, a piston causes the brake pressure to increase which causes brake pressure to be applied to the wheels of the vehicle. Hydraulic brakes are used on virtually all light duty vehicles and have been designed to work very well and they are not susceptible to environmental factors such as water.

Accordingly, a primary object of the present invention is to overcome of limitations current braking systems and provide a coupling to connect the hydraulic brake system of a towing vehicle to a hydraulic braking system on a towed vehicle or trailer that enables the braking system of the towing vehicle to also activate and operate the braking system of the towed vehicle.

### III. SUMMARY OF THE INVENTION

A hydraulic brake coupling that connects a vehicle hydraulic brake system of a vehicle to a trailer hydraulic brake system of a trailer. The hydraulic brake coupling includes a vehicle coupler that is fluidly connected to the vehicle hydraulic brake system, and a trailer coupler that is fluidly connected to the trailer brake system. The vehicle coupler and the trailer coupler are designed to make a fluid tight connection. When the vehicle coupler is coupled to the trailer coupler, activating the vehicle hydraulic brake system causes fluid pressure to pass from the vehicle brake system, through the vehicle coupler and the trailer coupler to the trailer brake system.

One feature of the present invention is that the vehicle coupler can include a pivot plate that enables the vehicle coupler to pivot about a horizontal axis. This allows the hydraulic brake coupling to remain aligned when the vehicle and trailer go over inclines or bumps.

Another feature of the present invention is that the vehicle coupler can include a rotation ring that enables the vehicle coupler to rotate about a vertical axis. The rotation ring can also have a central aperture, and a vehicle connection bolt can be inserted through the central aperture of the rotation ring to connect the vehicle coupler to the vehicle. This allows the hydraulic brake coupling to remain aligned when the vehicle and trailer go around curves, or the vehicle and the trailer are otherwise not aligned.

Yet another feature of the present invention is an emergency release member that enables the vehicle coupler to be decoupled from the trailer coupler without damaging the vehicle brake system. The vehicle or trailer coupler can include a release sleeve for disconnecting the vehicle coupler from the trailer coupler, and the emergency release member can include an emergency tether with one end attached to the release sleeve and the other end attached to the trailer. Then, when the trailer becomes disconnected and separates from the vehicle, the emergency tether can pull the release sleeve and decouple the vehicle coupler from the trailer coupler.

It is preferred that the hydraulic brake coupling be capable of both pivoting about a horizontal axis and rotating about a vertical axis. This allows the hydraulic brake coupling to maintain the same axis line as the trailer so that if a disconnection due to an emergency situation is required, the disconnection can be performed very easily.

The hydraulic brake coupling can include a vehicle coupler including a male body and a trailer coupler including a female body, the male and female bodies being designed to be coupled to one another. The male body has a downstream end, an upstream end and an interior cavity extending from the upstream end to the downstream end. The male body includes a protrusion at the downstream end that has an annular downstream face with a central aperture; an exterior circular groove and a spring biased cap that is moveable axially. When no external force is applied, the spring biased cap plugs the central aperture of the annular downstream face. The female body has a downstream end, an upstream end and an interior cavity extending from the upstream end to the downstream end. The female body includes an upstream face; a central post extending from the central cavity to the upstream face; an exterior fluid ring surrounding the central post at the upstream face, a spring biased annular ring moveable axially, a locking mechanism, and a release sleeve. The central post and the exterior fluid ring define an annular aperture therebetween at the upstream face, and, when no external force is applied, the spring biased annular ring plugs the annular aperture. The locking mechanism is capable of locking the annular ring axially downstream of the upstream face allowing fluid to pass through the annular aperture. The release sleeve is capable of releasing the locking mechanism. The upstream end of the male body is fluidly connected to the vehicle brake system in a fluid tight manner such that fluid of the vehicle hydraulic brake system fills the internal cavity of the male body and is prevented from exiting through the downstream end of the vehicle coupler by the spring biased cap. The downstream end of the female body is fluidly connected to the trailer brake system in a fluid tight manner such that fluid of the trailer hydraulic brake system fills the internal cavity of the female body and is prevented from exiting through the upstream end of the trailer coupler by the spring biased annular ring. The male body is coupled to the female body by aligning the downstream face of the protrusion with the upstream face of the female body and pushing the protrusion into the female body. This pushing causes the central post to push the spring biased cap in the upstream direction and causing the annular downstream face to push the spring biased annular ring in the downstream direction, until the locking mechanism of the female body engages the exterior circular groove of the protrusion which locks the male body and the female body together. The male body is decoupled from the female body by activating the release sleeve to release the locking mechanism and allowing the spring biased cap and the spring biased annular ring to decouple the female body and the male body. The spring biased cap then plugs the central aperture of the annular downstream face, and the spring biased annular ring plugs the annular aperture of the upstream face of the female body.

These and other features of the present invention will become more apparent to those skilled in the art in connection with a review of the drawings and detailed description of the invention set forth below.

### IV. BRIEF DESCRIPTION OF THE DRAWINGS

FIG. 1 is a schematic view of a vehicle towing a trailer showing the brake systems of both the vehicle and the trailer;

FIG. 2 is a schematic side view of the vehicle coupler and the trailer coupler;

FIG. 3 is a schematic side view of the vehicle coupler;

FIG. 4 is a schematic side view of the trailer coupler;

FIG. 5 is a blow-up diagram of the vehicle coupler;

FIG. 6 is a blow-up diagram of the trailer coupler;

FIG. 7 is a schematic end view of the vehicle coupler;

FIG. 8 is a schematic end view of the trailer coupler;

FIG. 9 is a cross-section of the body of the male vehicle coupler;.

FIG. 10 is cross-section of the body of the female vehicle coupler; and

FIG. 11 is cross-section of the body of the male vehicle coupler coupled to the body of the female vehicle coupler.

### V. DETAILED DESCRIPTION

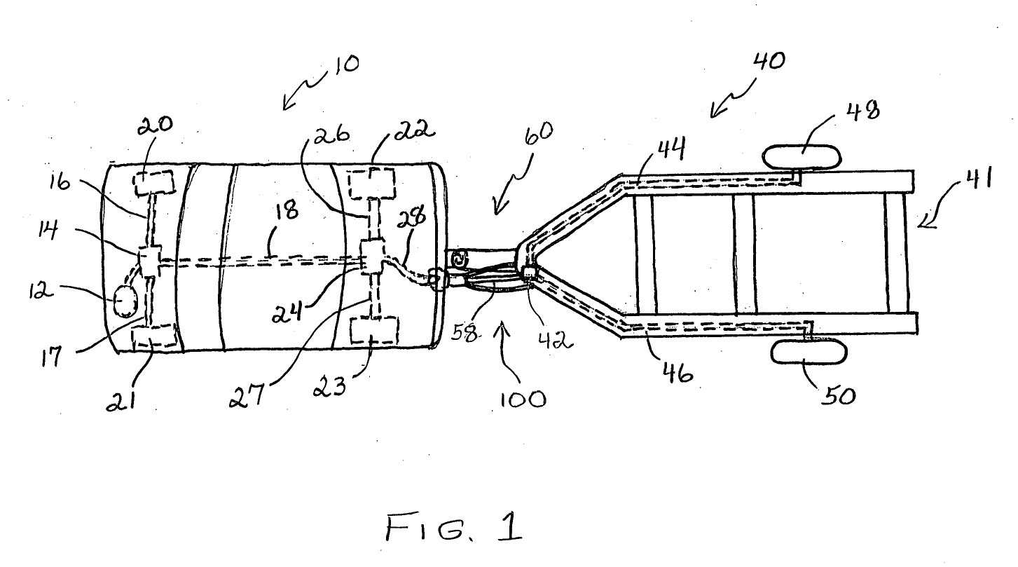

FIG. 1 shows a vehicle 10 pulling a trailer 40, the trailer 40 being connected to the vehicle 10 by a trailer hitch assembly 60 and a hydraulic brake coupling 100.

The vehicle 10 includes a brake pump 12 hydraulically coupled to a front brake junction box 14. The front brake junction box 14 is hydraulically coupled to a front right brake and tire assembly 20 by a front right brake line 16, and is hydraulically coupled to a front left brake and tire assembly 21 by a front left brake line 17. The front brake junction box 14 is also hydraulically coupled to a rear brake junction box 24 by a center brake line 18. The rear brake junction box 24 is hydraulically coupled to a rear right brake and tire assembly 22 by a rear right brake line 26, and is hydraulically coupled to a rear left brake and tire assembly 23 by a rear left brake line 27. The rear brake junction box 24 is also hydraulically coupled to the hydraulic brake coupling 100 by a vehicle brake line 28.

The trailer 40 includes a frame 41 to which is coupled a trailer brake junction box 42, a right trailer brake and tire assembly 48, and a left trailer brake and tire assembly 50. The trailer brake junction box 42 is hydraulically coupled to the right trailer brake and tire assembly 48 by a right trailer brake line 44, and is hydraulically coupled to the left trailer brake and tire assembly 50 by a left trailer brake line 46. The trailer brake junction box 42 is also hydraulically coupled to the hydraulic brake coupling 100 by a trailer brake line 58.

Thus, the hydraulic brake coupling 100 hydraulically connects the brake system of the vehicle 10 with the brake system of the trailer-40 forming a combined brake system. Considering the brake pump 12 of the vehicle 10 as the upstream end of the combined brake system and the trailer brake and tire assemblies 48, 50 as the downstream end of the combined brake system, the hydraulic brake coupling 100 is connected on the upstream side by the vehicle brake line 28 and is connected on the downstream side by the trailer brake line 58.

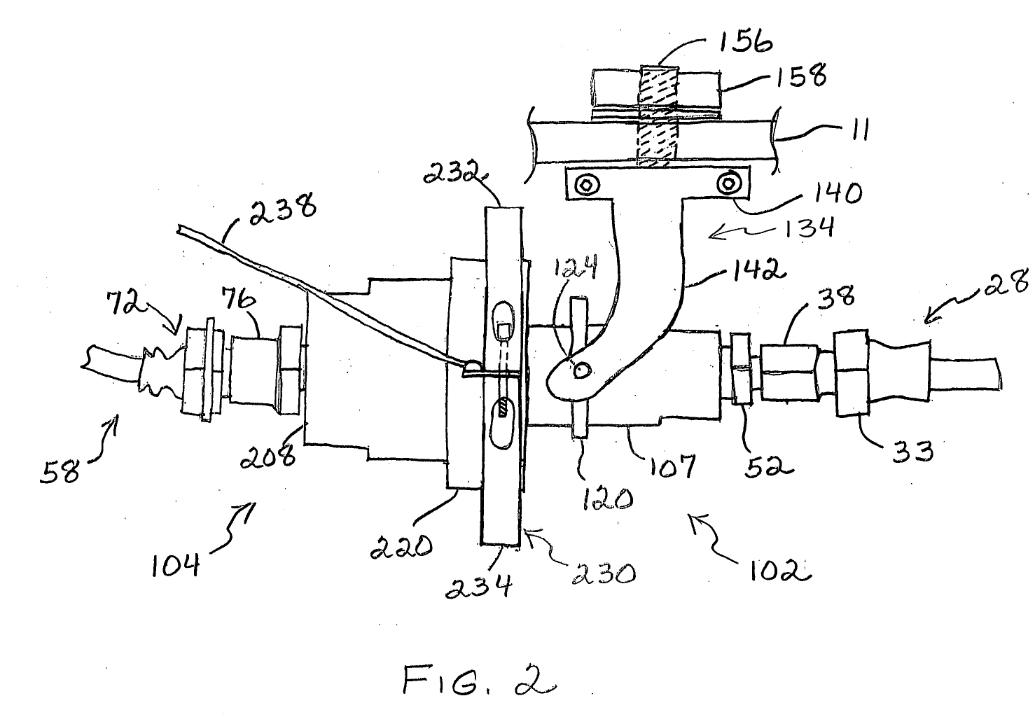

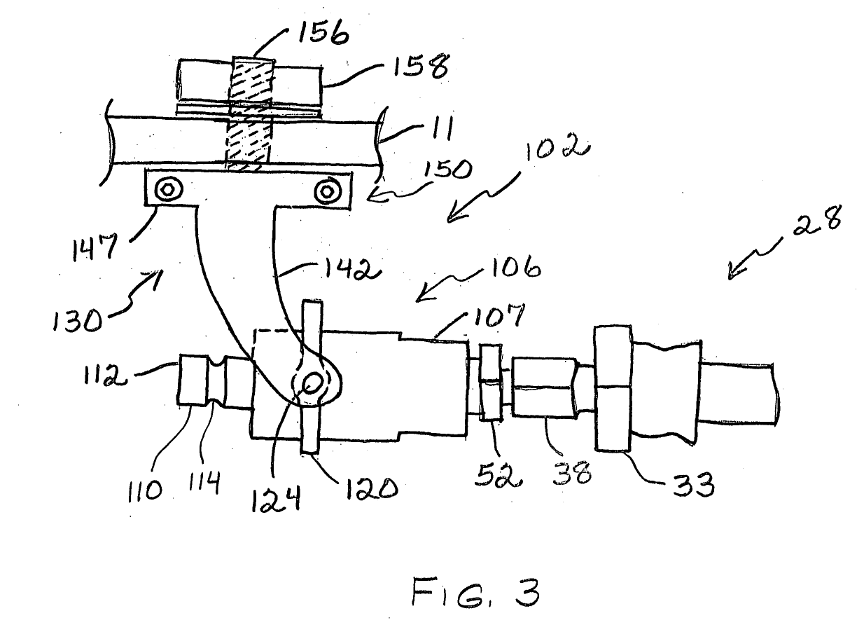

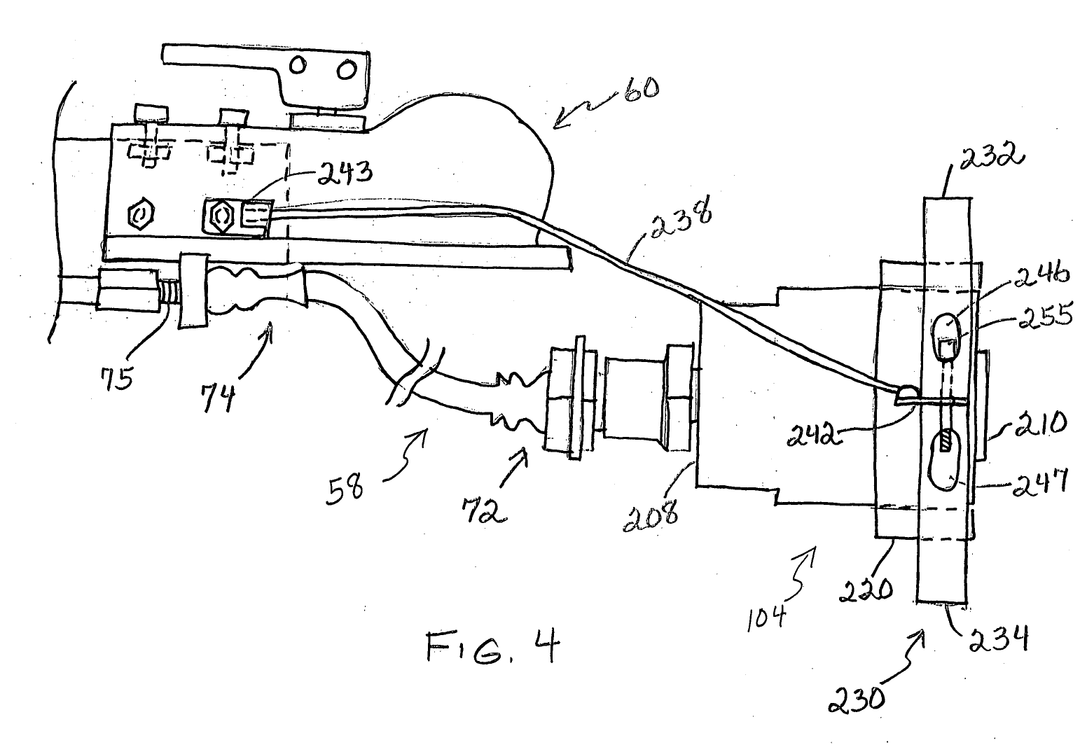

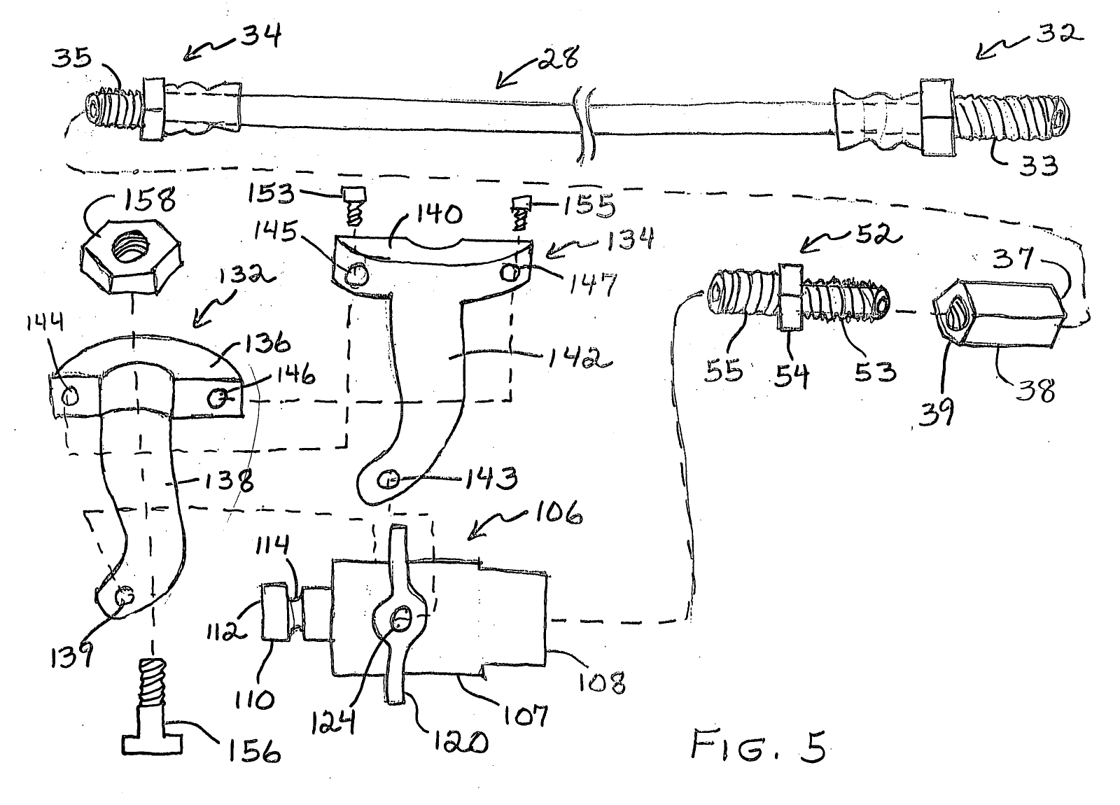

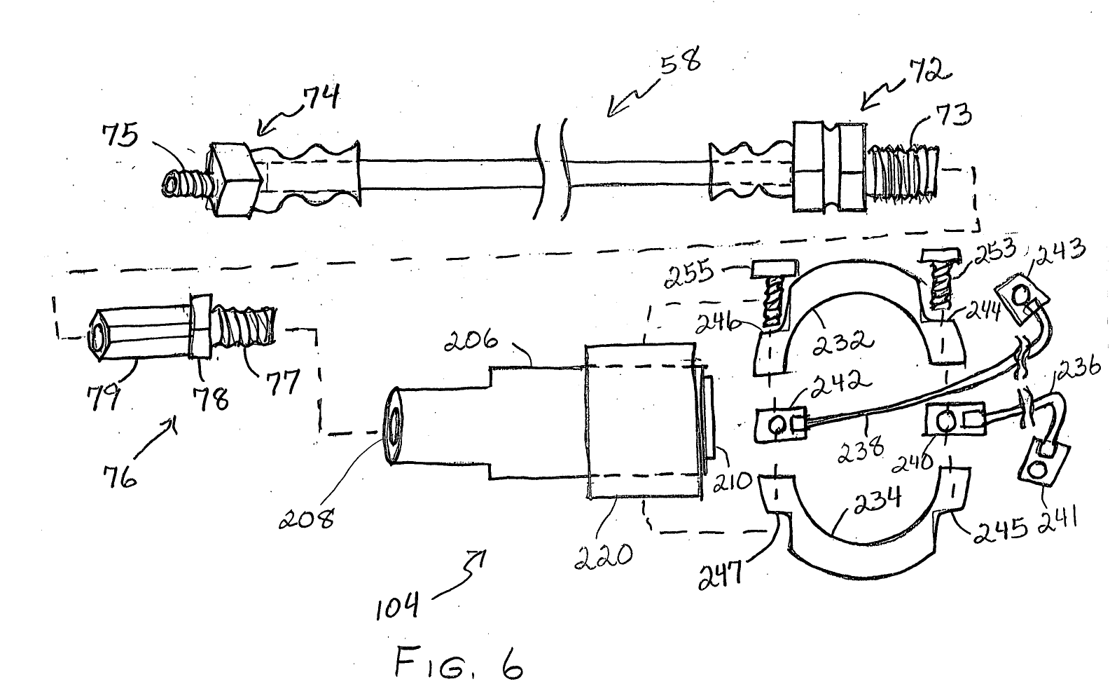

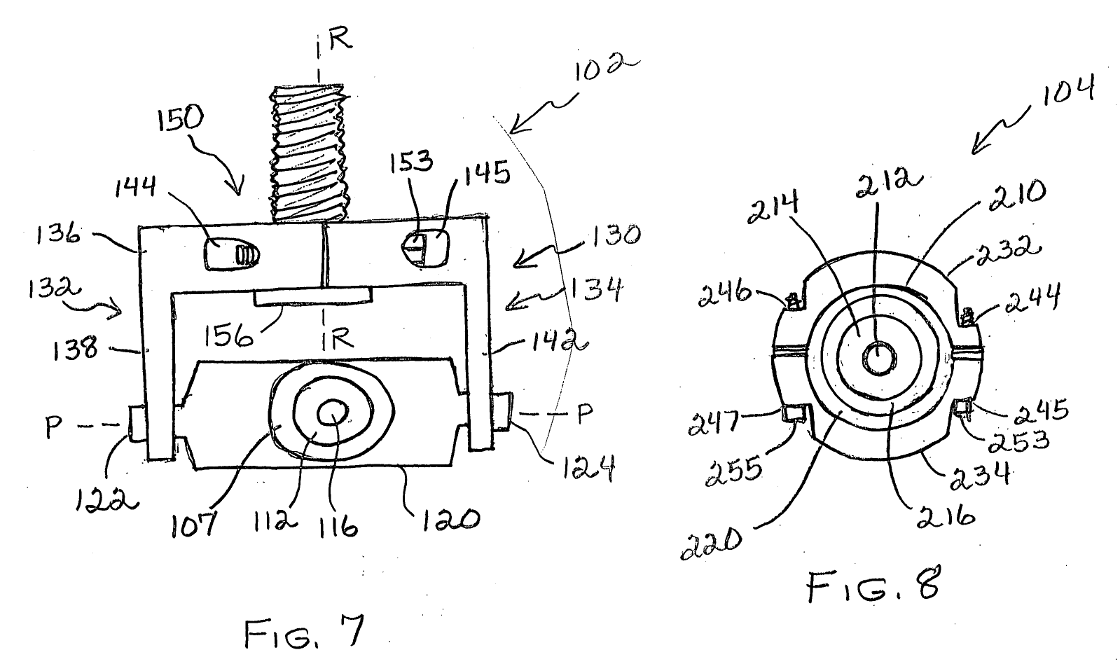

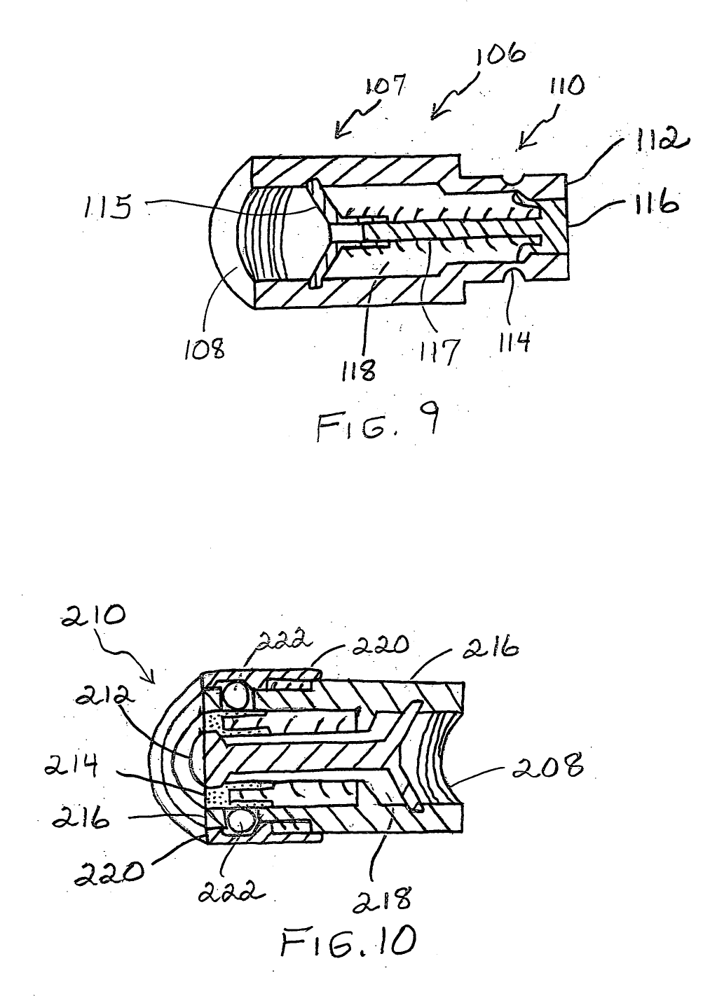

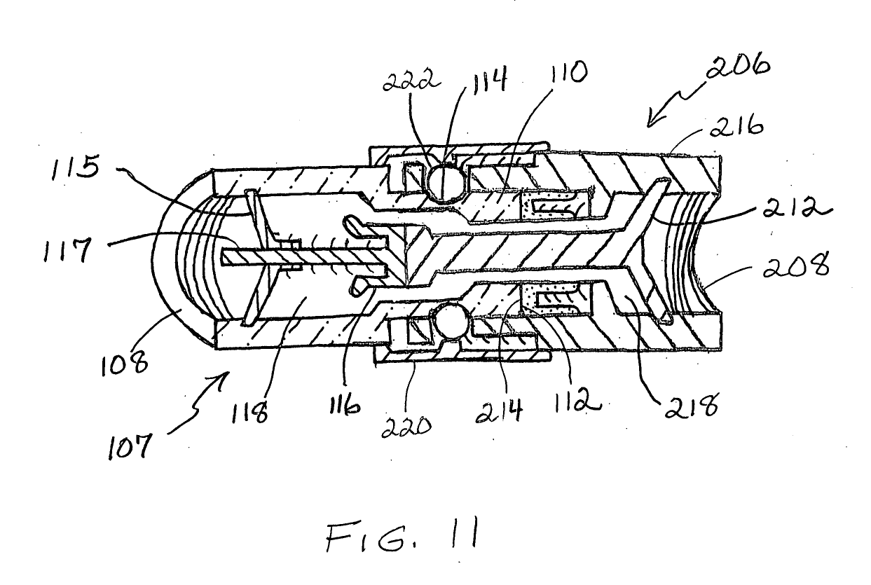

The hydraulic brake coupling 100 includes a male vehicle coupler 102 and a female trailer coupler 104. FIG. 2 shows the hydraulic brake coupling 100 with the male vehicle coupler 102 coupled to the female trailer coupler 104. FIGS. 3 and 4 show schematic views of the male vehicle coupler 102 and the female trailer coupler 104, respectively, separately (uncoupled). FIGS. 5 and 6 show exploded views of the male vehicle coupler 102 and the female trailer coupler 104, respectively. FIGS. 7 and 8 show end views of the male vehicle coupler 102 and the female trailer coupler 104, respectively. The male and female vehicle connectors 102, 104 are preferably made of materials that can withstand outside environmental conditions including water and salt water, such as stainless steel.

The male vehicle coupler 102 includes a generally cylindrical male body 106 having larger diameter, cylindrical upstream portion 107 and a smaller diameter, cylindrical downstream protrusion 110. The upstream portion 107 has an internally threaded upstream end 108. The downstream protrusion 110 has an annular downstream face 112, an exterior circular groove 114, and a spring biased cap 116 attached to an axially moveable post 117 that extends through a stationary stand 115 within the axial cavity 118 of the body 106. An axially-extending, interior cavity 118 runs through the length of the male body 106 from the internally threaded upstream end 108 of the upstream portion 107 to the annular downstream face 112 of the protrusion 110. The spring biased cap 116 is positioned in the center aperture of the annular downstream face 112 of the protrusion 110 and when not acted upon by external force, the spring biased cap 116 creates a fluid-tight seal at the downstream end of the interior cavity 118. When a force pushes the spring biased cap 116 axially into the interior of the protrusion 110, a fluid pathway is created from the interior cavity 118, around the interiorly forced cap 116 and through the center aperture in the annular downstream face 112 that was previously plugged by the spring biased cap 116. A suitable device for the cylindrical male body 106 is the male portion of an automatic flat face hydraulic sealing coupling available from CEJN (www.cejn.com).

The male vehicle coupler 102 also includes a lateral pivot plate 120, a pivot member 130 and a vehicle connection bolt 156. The lateral pivot plate 120 is fixedly coupled to the cylindrical body 106 and has a right side connector 122 and a left side connector 124. The pivot plate and pivot member allow the cylindrical male body 106 to be attached to the vehicle 10 while allowing the male body 106 to pivot about a horizontal axis P, and to rotate about a vertical axis R both of which are shown in FIG. 7. This movement allows the vehicle coupler 102 and the trailer coupler 104 to remain aligned during turns and on inclines. A particular embodiment of the lateral pivot plate 120 and the pivot member 130 is described below, though alternative implementations of attachment can be used to allow the vehicle coupler 102 and the trailer coupler 104 to remain aligned during turns and on inclines.

The pivot member 130 includes a right half 132 and a left half 134, the left half 134 being generally a mirror image of the right half 132. The components of the pivot member 130 are made of strong, rigid materials, preferably materials that can withstand environmental conditions including water and salt water, such as stainless steel. The right half 132 includes an upper right half ring 136 and a rigid right pivot arm 138 that extends downward from the middle of the exterior of the upper right half ring 136. The left half 134 includes an upper left half ring 140 and a rigid left pivot arm 142 that extends downward from the middle of the exterior of the upper left half ring 140. The upper right half ring 136 includes a forward right screw receiving cavity 144 on one side of right pivot arm 138 and a rear right screw receiving cavity 146 on the opposite side of right pivot arm 138. The upper left half ring 140 includes a forward left screw receiving cavity 145 on one side of the left pivot arm 142 and a rear left screw receiving cavity 147 on the opposite side of left pivot arm 142. A right pivot aperture 139 extends through the middle of the distal end of the right pivot arm 138 and is sized and shaped for receiving the right side connector 122 of the lateral pivot plate 120. A left pivot aperture 143 extends through the middle of the distal end of the left pivot arm 142 and is sized and shaped for receiving the left side connector 124 of the lateral pivot plate 120.

The right side connector 122 of the lateral pivot plate 120 is inserted in the right pivot aperture 139 of the right pivot arm 138, and the left side connector 124 of the lateral pivot plate 120 is inserted in the left pivot aperture 143 of the left pivot arm 142 such that the upper right half ring 136 and the upper left half ring 140 form a rotation ring 150 having a central aperture 152. When the right half 132 and the left half 134 of the pivot member 130 are properly positioned as described above, a forward pivot screw 153 is inserted through the forward right screw receiving cavity 144 of the upper right half ring 136 and into the forward left screw receiving cavity 145 of the upper left half ring 140, and a rear pivot screw 155 is inserted through the rear right screw receiving cavity 146 of the upper right half ring 136 and into the rear left screw receiving cavity 147 of the upper left half ring 140. The forward pivot screw 153 and the rear pivot screw 155 fixedly couple the right half 132 and the left half 134 of the pivot member 130 together, which firmly holds the pivot plate 132 and the cylindrical male body 106 between the right pivot arm 138 and the left pivot arm 142. The pivot plate 132 and the cylindrical male body 106 can pivot on the horizontal axis P between the right pivot arm 138 and the left pivot arm 142.

The vehicle connection bolt 156 is inserted through the central aperture 152 of the rotation ring 150 formed by the upper right half ring 136 and the upper left half ring 140 of the pivot member 130. The vehicle connection bolt 156 extends through the pivot member 130 and the frame 11 of the vehicle 10 and is fastened by a nut 158 to securely fasten the pivot member 130 and the entire male vehicle coupler assembly 102 to the vehicle 10. The pivot member 130 and the cylindrical male body 106 can rotate about the vertical axis R that extends through the central aperture 152 of the rotation ring 150.

The vehicle brake line 28 has an upstream end 32 with a threaded upstream connector 33 and a downstream end 34 with a threaded downstream connector 35. The upstream connector 33 is connected to the rear brake junction box 24 of the vehicle 10, and the downstream connector 35 is connected to the internally threaded upstream end 108 of the body 106 of the male vehicle coupler 102. The connection between the downstream connector 35 of the vehicle brake line 28 and the internally threaded upstream end 108 of the male vehicle coupler 102 can be made using a connection nut 38 and a dual, externally threaded connector 52. The connection nut 38 has an upstream end 37 and a downstream end 39. The dual, externally threaded connector 52 has an upstream threaded portion 53, a downstream threaded portion 55 and a central tightening grip 54. The downstream connector 35 of the vehicle brake line 28 is connected to the upstream end 37 of the connection nut 38. The upstream threaded portion 53 of the dual connector 52 is connected to the downstream end 39 of the connection nut 38. The downstream threaded portion 55 of the dual connector 52 is screwed into the internally threaded upstream end 108 of the body 106 of the vehicle coupler 102.

This connection of the vehicle coupler 102 creates a fluid tight passageway from the brake system of the vehicle 10 to the vehicle coupler 102 through the vehicle brake line 28, the connection nut 38 and the dual connector 52 into the interior cavity 118 of the body 106 which is capped at the downstream end by the spring biased cap 116. The body 106 of the vehicle coupler 102 can rotate about the vertical axis R that extends through the connection bolt 156 which is fastened to the frame 11 of the vehicle 10. The body 106 can also pivot about the horizontal axis P that extends through the lateral connectors 122, 124 of the pivot plate 120 and the pivot apertures 139, 143 of the pivot member 130.

The female trailer coupler 104 includes a generally cylindrical female body 206 having an internally threaded downstream end 208, an upstream face 210, and a release sleeve 220. Interior to the female body 206 is a fixed central post 212, a spring biased annular ring 214, a fixed exterior fluid ring 216 and a plurality of engagement balls 222. An axially-extending, interior cavity 218 runs through the length of the female body 206 from the internally threaded downstream end 208 to the upstream face 210. The spring biased annular ring 214 is positioned in the upstream face 210 so that when it is not acted upon by external force, the spring biased annular ring 214 creates a fluid-tight seal at the upstream end of the interior cavity 218 and except for the downstream end 208, the female body has a fluid tight seal throughout When a force pushes the spring biased annular ring 214 axially into the interior of the female body 206, the engagement balls 222 can move radially, toward the central post 212, and the release sleeve 220 can be moved upstream relative to the upstream face 210 to lock the engagement balls 222 centrally and hold the spring biased annular ring 214 downstream of the upstream face 210. This creates a fluid pathway from the interior cavity 218, around the interiorly forced annular ring 214 and through the annular aperture in the upstream face 210 between the center post 212 and the exterior fluid ring 216 that was previously plugged by the spring biased annular ring 214. The fluid pathway through the upstream face 210 can be closed by sliding the release sleeve 220 downstream relative to upstream face 210 which unlocks the central biasing of the engagement balls 222, and the spring bias of the annular ring 214 pushes the engagement balls 222 radially outward away from the central post 212 which allows the spring biased annular ring 214 to move to the upstream face 210 and plug the annular aperture in the upstream face 210 between the center post 212 and the exterior fluid ring 216. A suitable device for the cylindrical female body 206 is the female portion of an automatic flat face hydraulic sealing coupling available from CEJN (www.cejn.com) that corresponds to the male portion described above.

The female trailer coupler 104 also includes an emergency release member 230. The emergency release member 230 includes a top half 232, a bottom half 234, a right emergency tether 236 and a left emergency tether 238. The bottom half 234 of the emergency release member 230 is generally a mirror image of the top half 232. The components of the emergency release member 230 are made of strong, rigid materials, preferably materials that can withstand environmental conditions including water and salt water. The interior of the top half 232 and the bottom half 234 are sized and shaped to firmly fit around the exterior of the release sleeve 220. The top half 232 includes a top right screw receiving cavity 244 and a top left screw receiving cavity 246. The bottom half 234 includes a bottom right screw receiving cavity 245 and a bottom left screw receiving cavity 247. The right emergency tether 236 includes a proximal connector 240 and a distal connector 241. The left emergency tether 238 includes a proximal connector 242 and a distal connector 243.

A right side screw 253 is inserted through the top right screw receiving cavity 244 of the top half 232, through the proximal connector 240 of the right emergency tether 236, and into the bottom right screw receiving cavity 245 of the bottom half 234. A left side screw 255 is inserted through the top left screw receiving cavity 246 of the top half 232, through the proximal connector 242 of the left emergency tether 238, and into the bottom left screw receiving cavity 247 of the bottom half 234. The right side screw 253 and the left side screw 255 fixedly couple the top half 232 and the bottom half 234 of the emergency release member 230 together, and fixedly couple the emergency release member 230 against the exterior of the release sleeve 220, and also firmly hold the proximal connectors 240, 244 of the emergency tethers 236, 238 in place with the release sleeve 220.

The distal connectors 241, 243 of the emergency tethers 236, 238 are connected to the trailer frame 41 or a trailer hitch assembly 60 that is connected to the trailer frame 41. FIG. 4 shows the distal connector 243 of the left emergency tether connected to the trailer hitch assembly 60.

The trailer brake line 58 has an upstream end 72 with a threaded upstream connector 73 and a downstream end 74 with a threaded downstream connector 75. The upstream connector 73 is connected to the internally threaded downstream end 208 of the body 206 of the female trailer coupler 104 the downstream connector 75 is connected to trailer brake junction box 42 of the trailer 40. The connection between the upstream connector 73 of the trailer brake line 58 and the internally threaded downstream end 208 of the female trailer coupler 104 can be made using a dual nut-externally threaded connector 76. The dual nut-externally threaded connector 76 has an upstream threaded portion 77, a downstream nut portion 79 and a central tightening grip 78. The upstream connector 73 of the trailer brake line 58 is connected to the downstream nut portion 79 of the dual connector 76. The upstream threaded portion 77 of the dual connector 76 is screwed into the internally threaded downstream end 208 of the body 206 of the trailer coupler 104.

This connection of the trailer coupler 104 creates a fluid tight passageway from the brake system of the trailer 40 to the trailer coupler 104 through the trailer brake line 58 and the dual connector 76 into the interior cavity 218 of the body 206 which is capped at the upstream end by the spring biased annular ring 214. The emergency tethers 236, 238 connect the trailer frame 41 and/or the trailer hitch assembly 60 to the release sleeve 220 of the body 206.

The vehicle coupler 102 and the trailer coupler 104 are designed to matingly fit together to create a fluid tight connection between the brake system of the vehicle 10 and of the trailer 40. By properly aligning the downstream face 112 of the protrusion 110 of the male vehicle coupler 102 and the upstream face 210 of the female trailer coupler 104, the protrusion 110 of the male vehicle coupler 102 can be inserted into the female body 206 of the female trailer coupler 104. When properly aligned, the central post 212 of the female trailer coupler 104 aligns with the spring biased cap 116 of the male vehicle coupler 102 and the spring biased annular ring 214 of the female trailer coupler 104 aligns with the annular downstream face 112 of the male vehicle coupler 102. By pushing the protrusion 110 of the male vehicle coupler 102 into body 206 of the female trailer coupler 104, the central post 212 of the female trailer coupler 104 pushes the spring biased cap 116 of the male vehicle coupler 102 axially upstream into the cavity 118, and the annular downstream face 112 of the male vehicle coupler 102 pushes the spring biased annular ring 214 of the female trailer coupler 104 axially downstream into the female body 206 between the central post 212 and the exterior fluid ring 216. When the protrusion 110 is pushed sufficiently far into the female body 206, the engagement balls 222 of the female body 206 can protrude into the circular groove 114 of the protrusion 110 and the release sleeve 220 can be moved axially in the upstream direction to lock the engagement balls 222 in the circular groove 114. With the engagement balls 222 locked in the circular groove 114 of the protrusion 110, the male vehicle connector 102 and the female trailer connector 104 are locked together creating a fluid tight passageway between the interior cavity 118 of the vehicle coupler 102 and the interior cavity 218 of the trailer coupler 104. The passageway extends from interior cavity 118 of the vehicle coupler 102, through the center aperture of the annular downstream face 112 of the protrusion 110 that was previously plugged by the spring biased cap 116 and around the center post 212, through the annular aperture in the upstream face 210 between the center post 212 and the exterior fluid ring 216 that was previously plugged by the spring biased annular ring 214 and between the interiorly forced annular ring 214 and the central post 212 of the female body 206 and into the interior cavity 218 of the trailer coupler 104.

By pulling the release sleeve 220 axially in the downstream direction, the vehicle coupler 102 can be decoupled from the trailer coupler 104. When the release sleeve 220 is pulled in the downstream direction, the engagement balls 222 are free to move radially outward (away from the central post 212). The force of the spring biased cap 116 against the central post 212 and the force of the spring biased annular ring 214 against the annular downstream face 112 push the engagement balls 222 radially outward, out of the circular groove 114 of the protrusion 110, which releases the protrusion 110 of the male vehicle coupler 102. Then the spring biased cap 116 and annular ring 214 push the protrusion 110 out of the body 206 of the female trailer coupler 104. The spring biased cap 116 then plugs the central aperture of the annular downstream face 112 of the protrusion 110 creating a fluid tight seal at the downstream end of the vehicle connector 102. The spring biased annular ring 214 also plugs the annular aperture between the center post 212 and the exterior fluid ring 216 of the female body 206 creating a fluid tight seal at the upstream end of the trailer connector 104.

The connection and disconnection of the vehicle coupler 102 and the trailer coupler 104 can be performed with no significant loss of fluid from the brake lines and without introducing air into the brake lines of the vehicle 10 or the trailer 40. This is important so that the brake coupling 100 can be connected and disconnected multiple times without compromising the brake systems of the vehicle 10 or the trailer 40. Standard brake pressure is between 3,200 psi and 3,400 psi. For this reason, it is recommended that the brake coupling 100 be rated to pressures of 3,600 psi or above.

The emergency tethers 236, 238 are generally shorter than the trailer brake line 58 so that if the trailer 40 disconnects from the vehicle 10 during transit, causing the trailer 40 to move downstream relative to the vehicle 10, the tethers 236, 238 will pull the release sleeve 220 in the downstream direction disconnecting the trailer coupler 104 from the vehicle coupler 102 before physical damage is caused to the trailer brake line 58 or the brake systems of the vehicle 10 or the trailer 40. This is important because if you had a situation where the trailer 40 and the vehicle 10 are moving apart because the trailer 40 disconnects from the vehicle 10 while in transit, the weakest component in the combined brake system would tend to break. Typically, this might be the hydraulic brake lines of either the vehicle 10 or the trailer 40. If this would occur, an open end of the brake line would be created and, when the brakes were applied on the vehicle 10, the brake fluid would squirt out the brake line causing the vehicle 10 to loose its braking capability. The tethers 236, 238 provide a safety feature by causing the weakest point in the combined brake system to be the tethered release sleeve 220 which when pulled downstream, away from the vehicle 10, releases the trailer coupler 104 from the vehicle coupler 102 before damaging forces can be applied to the brake lines of either the vehicle 10 or the trailer 40.

Having described the invention in detail, it will be appreciated that variations and modifications can exist within the scope and spirit of the invention as defined by the appended claims.

1. A hydraulic brake coupling for connecting a vehicle hydraulic brake system of a vehicle to a trailer hydraulic brake system of a trailer, said hydraulic brake coupling comprising:
a vehicle coupler fluidly connected to the vehicle brake system; and
a trailer coupler fluidly connected to the trailer brake system, said trailer coupler being designed to make a fluid tight connection to said vehicle coupler; wherein, when said vehicle coupler is coupled to said trailer coupler, activating the vehicle hydraulic brake system causes fluid pressure to pass from the vehicle brake system, through said vehicle coupler and said trailer coupler to the trailer brake system.

2. The hydraulic brake coupling of claim 1, wherein said vehicle coupler is mounted on the vehicle.

3. The hydraulic brake coupling of claim 1, wherein said vehicle coupler further comprises a pivot plate, said pivot plate enabling said vehicle coupler to pivot about a horizontal axis.

4. The hydraulic brake coupler of claim 3, wherein said vehicle coupler further comprises a pivot member comprising a right pivot arm and a left pivot; wherein said pivot plate extends between said right pivot arm and said left pivot arm.

5. The hydraulic brake coupler of claim 4, wherein said vehicle coupler further comprises a vehicle connection bolt, and wherein said pivot member further comprises a rotation ring having a central aperture, said right pivot arm extending axially downward from said rotation ring, and said left pivot arm extending axially downward from the opposite side of said rotation ring as said right pivot arm; said vehicle connection bolt being inserted through said rotation ring to connect said vehicle coupler to the vehicle, said rotation ring enabling said vehicle coupler to rotate about said vehicle connection bolt.

6. The hydraulic brake coupling of claim 5, further comprising an emergency release member, said emergency release member enabling said vehicle coupler to be decoupled from said trailer coupler without damaging the vehicle brake system.

7. The hydraulic brake coupling of claim 6, wherein one of said vehicle coupler and said trailer coupler further comprises a release sleeve for disconnecting said vehicle coupler from said trailer coupler, and wherein said emergency release member further comprises an emergency tether having a proximal end and a distal end, said proximal end being attached to said release sleeve and said distal end being attached to said trailer, wherein, when the trailer becomes disconnected and separates from the vehicle, said emergency tether pulls said release sleeve releasing said vehicle coupler from said trailer coupler.

8. The hydraulic brake coupling of claim 3, further comprising a rotation ring, said rotation ring enabling said vehicle coupler to rotate about a vertical axis.

9. The hydraulic brake coupling of claim 8, further comprising an emergency release member, said emergency release member enabling said vehicle coupler to be decoupled from said trailer coupler without damaging the vehicle brake system.

10. The hydraulic brake coupling of claim 9, wherein one of said vehicle coupler and said trailer coupler further comprises a release sleeve for disconnecting said vehicle coupler from said trailer coupler, and wherein said emergency release member further comprises an emergency tether having a proximal end and a distal end, said proximal end being attached to said release sleeve and said distal end being attached to said trailer, wherein, when the trailer becomes disconnected and separates from the vehicle, said emergency tether pulls said release sleeve releasing said vehicle coupler from said trailer coupler.

11. The hydraulic brake coupling of claim 3, further comprising an emergency release member, said emergency release member enabling said vehicle coupler to be decoupled from said trailer coupler without damaging the vehicle brake system.

12. The hydraulic brake coupling of claim 1, further comprising a rotation ring, said rotation ring enabling said vehicle coupler to rotate about a vertical axis.

13. The hydraulic brake coupling of claim 1, further comprising an emergency release member, said emergency release member enabling said vehicle coupler to be decoupled from said trailer coupler without damaging the vehicle brake system.

14. A hydraulic brake coupling for connecting a vehicle hydraulic brake system of a vehicle to a trailer hydraulic brake system of a trailer, said hydraulic brake coupling comprising:
a vehicle coupler comprising a male body having a downstream end, an upstream end and an interior cavity extending from said upstream end to said downstream end, said male body comprising a protrusion at said downstream end, said protrusion comprising
an annular downstream face having a central aperture,
an exterior circular groove and
a spring biased cap moveable axially, said spring biased cap plugging said central aperture of said annular downstream face when no external force is applied, said upstream end of said male body being fluidly connected to the vehicle brake system in a fluid tight manner such that fluid of the vehicle hydraulic brake system fills said internal cavity of said male body and is prevented from exiting through said downstream end of said vehicle coupler by said spring biased cap when no external force is applied; and
a trailer coupler comprising a female body designed to be coupled to said male body, said female body having a downstream end, an upstream end and an interior cavity extending from said upstream end to said downstream end, said female body comprising
an upstream face;
a central post extending from said central cavity to said upstream face;
an exterior fluid ring surrounding said central post at said upstream face, said central post and said exterior fluid ring defining an annular aperture therebetween at said upstream face;
a spring biased annular ring moveable axially, said spring biased annular ring plugging said annular aperture when no external force is applied;
a locking mechanism capable of locking said annular ring axially downstream of said upstream face allowing fluid to pass through said annular aperture; and
a release sleeve capable of releasing said locking mechanism, said downstream end of said female body being fluidly connected to the trailer brake system in a fluid tight manner such that fluid of the trailer hydraulic brake system fills said internal cavity of said female body and is prevented from exiting through said upstream end of said trailer coupler by said spring biased annular ring when no external force is applied;
wherein said male body is coupled to said female body by aligning said downstream face of said protrusion with said upstream face of said female body and pushing said protrusion into said female body, thereby causing said central post to push said spring biased cap in the upstream direction and causing said annular downstream face to push said spring biased annular ring in the downstream direction, until said locking mechanism of said female body engages said exterior circular groove of said protrusion locking said male body and said female body; and said male body is decoupled from said female body by activating said release sleeve to release said locking mechanism and allowing said spring biased cap and said spring biased annular ring to decouple said female body and said male body, said spring biased cap plugging said central aperture of said annular downstream face and said spring biased annular ring plugging said annular aperture of said upstream face of said female body.

15. The hydraulic brake coupling of claim 14, wherein said vehicle coupler further comprises a pivot plate, said pivot plate enabling said vehicle coupler to pivot about a horizontal axis.

16. The hydraulic brake coupler of claim 15, wherein said vehicle coupler further comprises a pivot member comprising a right pivot arm and a left pivot; wherein said pivot plate extends between said right pivot arm and said left pivot arm.

17. The hydraulic brake coupler of claim 16, wherein said vehicle coupler further comprises a vehicle connection bolt, and wherein said pivot member further comprises a rotation ring having a central aperture, said right pivot arm extending axially downward from said rotation ring, and said left pivot arm extending axially downward from the opposite side of said rotation ring as said right pivot arm; said vehicle connection bolt being inserted through said rotation ring to connect said vehicle coupler to the vehicle, said rotation ring enabling said vehicle coupler to rotate about said vehicle connection bolt.

18. The hydraulic brake coupling of claim 14, further comprising an emergency release member connected to said release sleeve, said emergency release member activating said release sleeve to decouple said vehicle coupler from said trailer coupler without damaging the vehicle brake system.

19. The hydraulic brake coupling of claim 14, further comprising an emergency tether having a proximal end and a distal end, said proximal end being attached to said release sleeve and said distal end being attached to said trailer, wherein, when the trailer becomes disconnected and separates from the vehicle, said emergency tether pulls said release sleeve releasing said vehicle coupler from said trailer coupler.

20. The hydraulic brake coupling of claim 14, further comprising a rotation ring, said rotation ring enabling said vehicle coupler to rotate about a vertical axis.
